(19) United States
(12) Patent Application Publication
(10) Pub. No.: US 2026/0074501 A1
(43) Pub. Date: Mar. 12, 2026

(54) BURIED WIRE METHOD AND APPARATUS FOR THE LUNAR SURFACE

(71) Applicant: Blue Origin Manufacturing, LLC, Huntsville, AL (US)

(72) Inventors: Patrick Michael McGarey, South Pasadena, CA (US); Lauren Thomas Sagan, Los Angeles, CA (US); Jesse Dylan Tarnas, Los Angeles, CA (US)

(21) Appl. No.: 18/883,024

(22) Filed: Sep. 12, 2024

(51) Int. Cl. H02G 9/02; H01B 13/14; H02G 1/06

(52) U.S. Cl. CPC H02G 9/02; H01B 13/146; H02G 1/06

(57) ABSTRACT

A method and system is presented for placing and burying a conductive material, such as a wire, in lunar regolith. The method may include excavating a trench, placing the conductive material in the trench, and subsequently backfilling the trench to bury the conductive material. The system may include an excavation plow, a reverse plow, and a conductive material dispenser. For example, the excavation plow may remove regolith out of the lunar surface to form a trench. The reverse plow may bury the conductive material with the regolith by refilling a portion of the trench where the conductive material has just been placed. In some embodiments, the conductive material dispenser may be configured to dispense a molten conductive material that is cast in place in the trench to form wire. In other embodiments, the conductive material dispenser may be configured to dispense a prefabricated wire from a spool.

### BACKGROUND

Planned activities for future Moon landings far exceed those of the Apollo missions. There is currently a great deal of focus on methods, materials, and technologies that will allow for habitats, massive exploration, and mining on the Moon. Such activities will need energy and ways of transporting energy from locations of generation to locations of use. Electrical power may be delivered via wires from a solar generation plant to a various facilities, such as living habitats, water extraction plants, and oxygen-producing plants, just to name a few examples. In addition to delivering electrical power, wires on the Moon may be used for data and communication distribution systems.

A serious limitation of the lunar surface is that materials traditionally used on Earth for, say the construction of a power transmission line system, are not readily available. As such, it is desirable to have a universally applicable process and equipment to extract materials out of the lunar regolith of arbitrarily varying composition utilizing the available materials found on the surface of the Moon to construct power transmission lines, for example.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a schematic cross-section of a buried-wire placement system, according to some embodiments.

FIG. 2 is a schematic side view of a cross-section of a process of placing a wire at the bottom of a trench, according to some embodiments.

FIG. 3 is a schematic side view of a cross-section of a process of placing a wire in a trough at the bottom of a trench, according to some embodiments.

FIG. 4 is a schematic side view of a cross-section of a process of placing a wire in a trough at the bottom of a trench with a nozzle in the trough, according to some embodiments.

FIG. 5 is a schematic cross-section of a trench with a rectangular wire partially filling the bottom of the trench, according to some embodiments.

FIG. 6 is a schematic cross-section of a trench with a rectangular wire filling the bottom of the trench, according to some embodiments.

FIG. 7 is a schematic cross-section of a trench with a wire filling a rectangular trough at the bottom of the trench, according to some embodiments.

FIG. 8 is a schematic cross-section of a trench with a wire filling a vertical trough at the bottom of the trench, according to some embodiments.

FIG. 9 is a schematic cross-section of a trench with a wire filling a round trough at the bottom of the trench, according to some embodiments.

FIG. 10 is a schematic cross-section of a trench with a wire over-filling a round trough at the bottom of the trench, according to some embodiments.

FIG. 11 is a top view of a process of excavating and refilling a trench during a process of placing and burying a wire, according to some embodiments.

FIG. 12 is a flow diagram of a process of placing a wire in a trench, according to some embodiments.

FIG. 13 is a schematic cross-section of a buried-wire placement system that dispenses prefabricated wire, according to some other embodiments.

### DETAILED DESCRIPTION

This disclosure describes, among other things, systems and methods for placing and burying a conductive material, such as a wire, in lunar regolith. For example, the method includes excavating a trench, placing the conductive material in the trench, and subsequently backfilling the trench to bury the conductive material. A system for performing such a method may include an excavation plow, a reverse plow, and a conductive material dispenser. For example, the excavation plow may remove regolith out of the lunar surface to form a trench. The reverse plow may bury the conductive material with the regolith by refilling a portion of the trench where the conductive material has just been placed. In some embodiments, the conductive material dispenser may be configured to dispense a molten conductive material and in other embodiments the conductive material dispenser may be configured to dispense a prefabricated wire from a spool. Because regolith in the lunar vacuum environment is an excellent insulator, the buried conductive material need not be electrically insulated and instead may be bare conductor. Thus, for example, the lunar regolith allows for burying a high voltage power transmission line directly in the lunar regolith, thus eliminating the need for electrical insulation of structures that suspend power transmission lines above the lunar surface.

Herein, examples and discussions focus on methods performed with lunar regolith on the Moon. Even so, many of these example methods may instead be directed to applications performed on Earth or other bodies in the solar system. An important difference, however, is that conductive soils of the Earth may likely preclude the use of buried uninsulated wire(s), whereas the Moon provides an important advantage in this respect.

In system embodiments for which the conductive material dispenser dispenses molten conductive material, the system may also include a chamber configured to melt the conductive material and hold the molten material until it is extruded and dispensed into a trench. These system embodiments allow for casting molten conductive material directly into a trench to be buried, thus avoiding use of prefabricated wire. Thus, in some implementations, wires and transmission lines may be made from a molten conductive material that is sourced from lunar regolith in order to utilize available materials found on the surface of the Moon.

In embodiments described herein, the conductive material is a metal, which may be referred to as a “wire” when the metal is at least partially in a solid state. Molten metal may be extruded from a nozzle having an aperture and flow rate that produces a filament (e.g., a strand) of molten metal. The aperture and flow rate may, at least in part, determine the cross-sectional shape and size of the filament. In some implementations, the filament may cool and solidify completely before it drops to the bottom of a trench as a wire. The solidified metal filament (e.g., wire) may remain sufficiently flexible so as to bend as it drops onto the bottom of the trench. In other implementations, the filament may cool and only partially solidify before it drops to the bottom of a trench. The filament's cross-sectional dimensions need not change as the filament (e.g., wire) contacts the trench bottom if the filament has sufficiently solidified. In still other implementations, the filament may cool but nevertheless remain in a liquid state when it drops to the bottom of a trench. The filament may then further cool to solidify and be cast in place on the trench bottom to form a wire. The solidified cast wire may have a cross-section determined, at least in part, by the cross-section of the trench bottom, the viscosity of the liquid filament in the trench bottom, and/or the rate of deposition onto the trench bottom, for example.

In some embodiments, a method for placing wire in a trench in lunar regolith may include using an excavation plow to remove regolith out of the lunar surface to form the trench, placing the wire in the trench, and burying the wire by using a reverse plow to refill a portion of the trench where the wire was just placed. In some implementations, the wire may be produced simultaneously with the placement of the wire in the trench. For example, as noted above, a vessel or chamber of molten metal may be extruded from a nozzle to form the wire directly in or over the just-excavated trench. The molten metal may be aluminum, which has a relatively low melting point among metals. The molten metal may cool relatively quickly from the instant it leaves the nozzle, remaining flexible in a plastic state and transforming into the wire as it drops from the nozzle into the trench. In some cases, as explained above, if the molten metal remains sufficiently in a deformable state (e.g., relatively low viscosity or liquid), then it will be cast in place when it drops onto the bottom of the trench. A bottom portion of the trench may be formed to create a predetermined cross-section of the wire in the trench. For example, a lower portion of the excavation plow may have a shape that forms a relatively small trough at the bottom of the trench. If this trough has a rectangular shape then the molten metal will be cast into a wire having a rectangular cross-section. If this trough has a round shape (e.g., the lower half of a semi-circle) then the molten metal will be cast into a wire having a semi-circular cross-section (e.g., a round bottom and flat top). Such casting into shapes is described below in greater detail.

In some embodiments, a buried-wire placement (BWP) system for performing the methods described above may be configured to operate on a moving vehicle. Accordingly, the BWP system may include an excavation plow at a front portion of the BWP system to remove regolith out of the lunar surface to form a trench, a chamber configured to melt a metal and temporarily hold the molten metal, a temperature control system to adjust the temperature of the molten metal, and a nozzle at a middle portion of the BWP system configured to extrude the molten metal into the trench to form a wire. The temperature of the extruded molten metal may be adjusted by the temperature control system to adjust the temperature of the extruded molten metal to be in a liquid state, a plastic state, or a solid state between the nozzle and a bottom of the trench, depending on the particular implementation. The system may also include a reverse plow, located at a back portion of the BWP system, configured to bury the wire with the regolith by refilling a portion of the trench that includes the wire. The excavation plow may be configured to form a bottom portion of the trench into a shape that creates a predetermined cross-section of the wire in the trench. For example, the predetermined cross-section may be rectangular or circular.

In some implementations, the nozzle, the excavation plow, and the reverse plow of the wire-dispensing system may be interconnected so as to be positioned substantially in a single line. In this configuration, excavating, placing wire, and backfilling may be performed sequentially along the single line as the vehicle and system drive forward over the lunar surface.

In some implementations, the system may include two (or more) nozzles to extrude molten metal into the trench to form two (or more) separate wires substantially parallel to each other.

The system may further include a number of components to perform various tasks. For example, the system may include a laser configured to sinter at least a portion of the trench before placement of the extruded molten metal in the trench. The system may also include a sensor to measure at least one electrical property of the extruded molten metal and the wire in the trench. Such a measurement(s) may occur while extruding the molten metal. Measured electrical properties may be current, voltage, resistance, and capacitance, just to name a few examples. Measurements may be for one or more wires. For example, if two wires are being placed in parallel, an electrical measurement may be their mutual capacitance.

In some embodiments, a BWP system configured to operate on a lunar vehicle may dispense prefabricated, bare (e.g., non-insulated) wire. The system may include an excavation plow at a front portion of the BWP system to remove regolith out of the lunar surface to form a trench, a spool holder configured to hold a spool of non-insulated wire, a dispenser at a middle portion of the BWP system configured to pull the non-insulated wire from the spool of the non-insulated wire and dispense the non-insulated wire into the trench, and a reverse plow at a back portion of the BWP system configured to bury the non-insulated wire with the regolith by refilling a portion of the trench that includes the non-insulated wire. In some implementations, the system may include two (or more) spool holders to dispense two (or more) separate wires substantially parallel to each other in a trench.

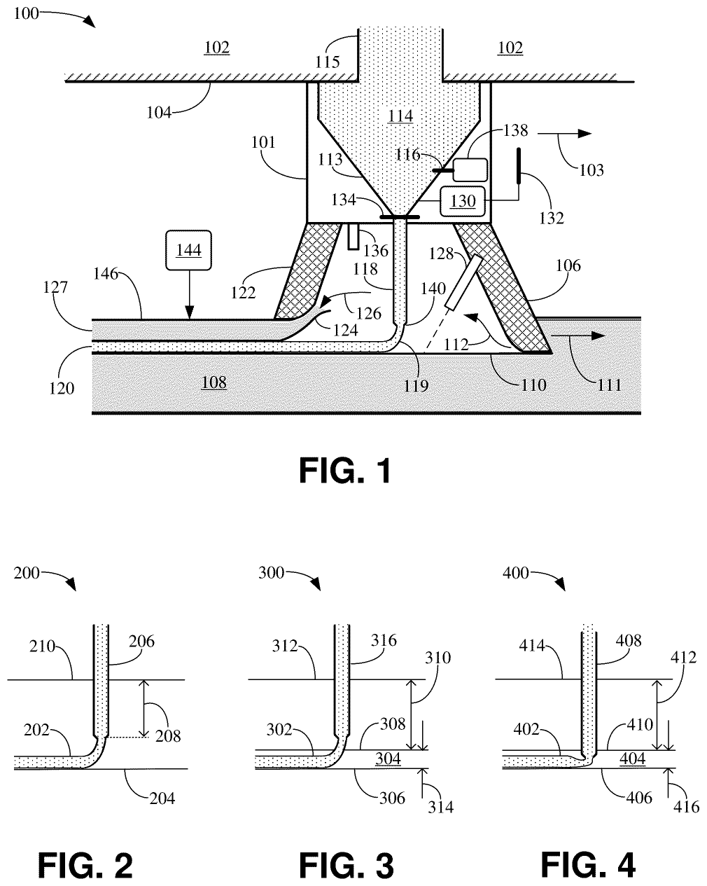

FIG. 1 is a schematic cross-section of a BWP system 100, according to some embodiments. The BWP system, which may be at least partially contained in a system body 101, may be configured to operate on a moving vehicle 102, as indicated by arrow 103. For example, the system body of BWP system 100 may be mounted to an underside 104 of vehicle 102. BWP system 100 may include an excavation plow 106 at a front portion of the BWP system to remove regolith 108 out of the lunar surface to form a trench 110. Excavation plow 106 pushes forward, as indicated by arrow 111, to force regolith 108 out and to one or both sides, indicated by arrow 112, of the developing trench. System 100 may include a chamber 113 configured to melt a metal, such as aluminum, and hold the molten metal 114. A feed channel or antechamber 115 may rise above system body 101 and into vehicle 102 where metal may be deposited and/or melted and subsequently dropped into chamber 113.

A temperature controller 116 may be configured to adjust the temperature of the molten metal in chamber 113. A nozzle 118 may be located at a middle portion of BWP system 100 to extrude molten metal 114 as a filament 119 into trench 110 to form a wire 120. The temperature of the extruded molten metal (e.g., the filament) may be adjusted by temperature controller 116 to adjust the temperature of the extruded molten metal to be in a molten state, a plastic state, or a solid state at various points between nozzle 118 and a bottom of the trench. A reverse plow 122 may be located at a back portion of BWP system 100 to bury the wire with excavated regolith 124 by refilling, as indicated by arrow 126, a portion of the trench that includes the wire. After the wire burying process, wire 120 may be buried under a layer 127 of regolith fill.

In some implementations, nozzle 118, excavation plow 106, and reverse plow 122 may be configured in BWP system 100 to be positioned substantially in a single line. For example, wire 120 may be placed in a middle of trench 110 behind excavation plow 106, followed by reverse plow 122.

BWP system 100 may include a laser 128 configured to sinter at least a portion of the trench bottom before placement of the extruded filament in the trench. For example, a diode laser or CO2 laser, just to name a few examples, may be used to heat and fuse regolith particles into a partially solid material. Such a process of sintering may be used to seal the bottom surface of the trench so as to smooth-out small regolith particles that may otherwise protrude upward into cast-in-place wire that is formed from molten metal. Laser 128 may be focused to a relatively high intensity at or near the bottom of the trench to create a swath of sintered regolith about the same width as the placed molten metal, for example.

BWP system 100 may include a sensor 130 to measure one or more electrical properties of the extruded filament and the wire in the trench while extruding molten metal from nozzle 118. For example, electrical continuity of wire 120 may be measured from a point at or near the bottom of chamber 113 to a remote point along the buried wire 120 that is relatively far from BWP system 100. In a particular measurement implementation, a voltage (e.g., a signal), which may be time-varying or constant, may be applied at the remote point and sensor 130 may detect the voltage to confirm wire continuity. In another particular measurement implementation, a voltage may be applied at sensor 130 and a remote sensor (not illustrated) may detect the voltage to confirm wire continuity. BWP system 100 may include an antenna-receiver system 132 for wirelessly receiving measurements or wire continuity confirmation from the remote sensor. Though conductivity of a metal is generally reduced at or above melt temperatures, the conductivity of a molten filament may likely be high enough to perform various continuity measurements of the filament and wire.

BWP system 100 may include a valve 134 for controlling flow of molten metal 114 through nozzle 118. An imaging sensor 136 may be focused on a portion of wire 120 on the bottom of trench 110 to capture images of the wire continuously (e.g., video) or from time to time. BWP system 100 may also include a processor 138 that may use pattern recognition techniques to analyze the captured images (or video) to determine one or more qualities of the wire on the bottom of the trench. Such qualities of the wire that may be measured and analyzed by the processor may be its thickness, width, albedo, temperature (e.g., via blackbody spectral measurements), and surface roughness, just to name a few examples.

Processor 138 may control valve 134 to adjust the flow of molten metal 114 based, at least in part, on the determined one or more qualities. The rate of flow, in coordination with the shape and size of a nozzle opening 140, may affect the size and shape of filament 119 of molten metal just before the filament contacts the bottom of the trench. Accordingly, the size of the resulting wire 120 may be controlled at least partially by the rate of flow.

In some implementations, BWP system 100 may be configured to dispense and form two (or more) wires substantially in parallel with each other in a trench. For example, though not illustrated, system 100 may have a second nozzle to form a second filament of molten metal that is deposited onto the trench bottom. Interestingly, neither of these wires, though relatively closely laid next to each other, will be electrically insulated, since the wires are formed directly from the molten metal. Lunar regolith, in the dry vacuum of the Moon, has a relatively high electrical resistivity and is thus a very good electrical insulator.

In some embodiments, BWP system 100 may be configured to place markers over buried wire 120. Such markers may help prevent damage to the buried wire from activities, such as driving heavy equipment or future excavations, on the lunar surface. For example, system 100 may include an apparatus 144 that plants small markers or flags into surface 146 on top of layer 127 of regolith fill. In some implementations, apparatus 144 may be configured to produce a particular texture to surface 146, such as cross-hatching or lines, that can distinguish surface 146 from the surroundings surfaces. This texture, which is effectively permanent if undisturbed by human activity, may be useful for indicating the presence of buried wire.

FIG. 2 is a schematic side view of a cross-section of a process 200 of placing a wire 202 at the bottom of a trench 204, according to some embodiments. For example, wire 202 may be the same as or similar to wire 120 and trench 204 may be the same as or similar to trench 110, described above. In process 200, a nozzle 206 may extrude molten metal at a depth 208 below the top 210 of the trench. With respect to the temperatures of the molten metal at the nozzle exit, ambient temperature (e.g., of the regolith), and the melting temperature of the metal, the distance and the span of time between the extrusion from the nozzle and contact with the bottom of the trench may generally determine what shape and size of wire 202 will be formed by the extruded filament of molten metal. For example, with all other things being equal, if distance 208 were reduced, the filament of molten metal may have more time to cool outside the nozzle and the shape and size of wire 202 may be affected.

FIG. 3 is a schematic side view of a cross-section of a process 300 of placing a wire 302 in a trough 304 at the bottom of a trench 306, according to some embodiments. One of the advantages of incorporating a trough at the bottom of a trench may be based on structural integrity of regolith excavation. For example, in some implementations, a trench having a relatively narrow width may be desired. But such a trench, having the desired depth for burying wire, may likely have unstable sides that could collapse, depending on the qualities and characteristics of the regolith. Accordingly, sides of the trench may be angled, as illustrated below, and a relatively shallow trough at the bottom of the trench may provide a desired cross-section (e.g., size and shape) for cast-in-place wire. In some example implementations, excavation plow 106 may be configured to form a bottom portion of the trench into a shape, such as trough 304, that creates a predetermined cross-section of the cast-in-place wire in the trench. For example, the trough may be formed by a protruding feature at the bottom of excavation plow 106. In some particular examples, the top 308 of trough 304 may have a depth 310 below the top 312 of trench 306. A depth 314 of the trough may be about 5% of depth 310, though claimed subject matter is not so limited.

In process 300, a nozzle 316 may extrude a filament of molten metal at a depth that is just above the top 308 of trough 304. Placing molten metal in a trough at the bottom of a trench may provide a number of benefits. For example, there is generally less volume of molten metal needed to fill a bottom of a trough compared to filling a bottom of a trench.

Also, the cross-sectional shape of the wire may be more tightly controlled when molten metal is cast in a trough as opposed to being cast in a trench.

FIG. 4 is a schematic side view of a cross-section of a process 400 of placing a wire 402 in a trough 404 at the bottom of a trench 406 with a nozzle 408 in the trough, according to some embodiments. In some particular examples, the top 410 of trough 404 may have a depth 412 below the top 414 of trench 406. A depth 416 of the trough may be about 5% of depth 412, though claimed subject matter is not so limited. With respect to the temperatures of the filament of molten metal at the nozzle exit, i) ambient temperature (e.g., of the regolith), ii) the melting temperature of the metal, and iii) the distance and the span of time between the extrusion from the nozzle and contact with the bottom of the trench may generally determine what shape and size of wire 402 will be formed by the molten metal. For example, with all other things being equal, the filament of molten metal may have more time to cool outside nozzle 316 of process 300 as compared to nozzle 408 in process 400 being in trough 404. In both processes, the shape and size of wires 302 and 402 may be affected accordingly.

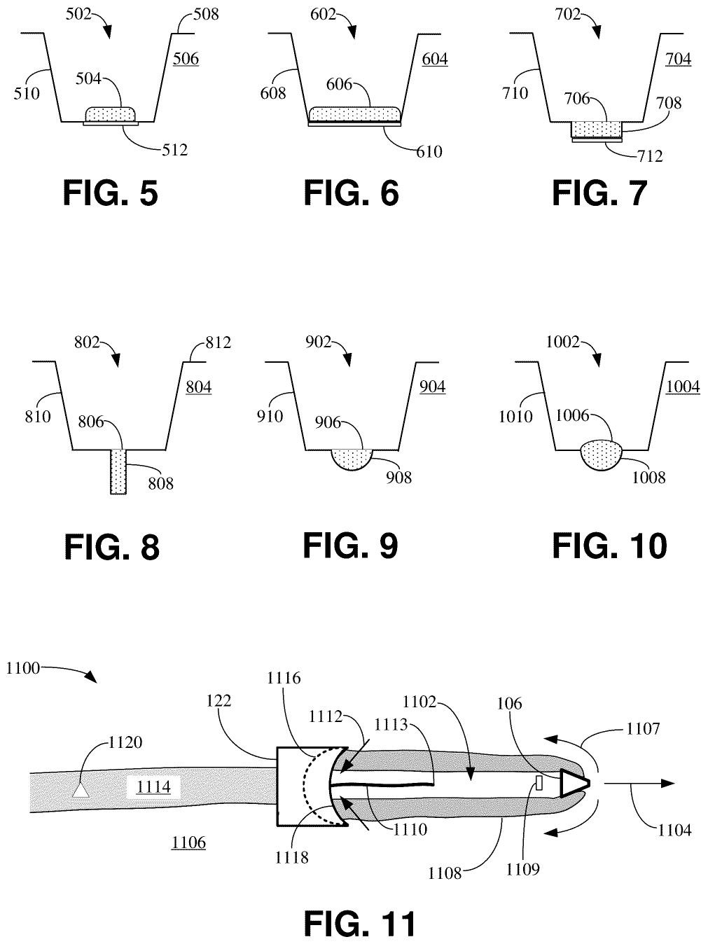

FIG. 5 is a schematic cross-section of a trench 502 with a cast-in-place rectangular wire 504 partially filling the bottom of the trench, according to some embodiments. Depending at least in part on the qualities (e.g., composition, texture, grain size, packing density, etc.) of regolith 506 from the lunar surface 508 down to a depth of the trench 502 being excavated, sides 510 may be excavated at an angle from vertical to create a structurally stable trench. In some implementations, at least a portion 512 of the bottom of trench 502 may be sintered using a laser, such as laser 128, for example. Cast-in-place rectangular wire 504 may only partially fill the bottom of trench 502 depending on the viscosity of the molten metal as it exits the nozzle.

FIG. 6 is a schematic cross-section of a trench 602 excavated in regolith 604 that includes a cast-in-place rectangular wire 606 that fills the bottom of the trench, according to some embodiments. Sides 608 may be excavated at an angle from vertical to create a structurally stable trench. In some implementations, at least a portion 610 of the bottom of trench 602 may be sintered using a laser, such as laser 128, for example. Cast-in-place rectangular wire 606 may fill the bottom of trench 602 depending on the viscosity of the molten metal as it exits the nozzle. For example, the molten metal that formed wire 606 may be less viscous than the molten metal that formed wire 504 in trench 502.

FIG. 7 is a schematic cross-section of a trench 702 excavated in regolith 704 that includes a cast-in-place wire 706 filling a rectangular trough 708 at the bottom of the trench, according to some embodiments. Sides 710 of trench 702 may be excavated at an angle from vertical to create a structurally stable trench. Though not illustrated, trough 708 may also have angled sides. In some implementations, at least a portion 712 of the bottom of trough 708 may be sintered using a laser, such as laser 128, for example. Cast-in-place rectangular wire 706 may fill the bottom of trough 708 depending on the viscosity of the molten metal as it exits the nozzle.

FIG. 8 is a schematic cross-section of a trench 802 excavated in regolith 804 that includes a cast-in-place wire 806 filling a vertical trough 808 at the bottom of the trench, according to some embodiments. Sides 810 of trench 802 may be excavated at an angle from vertical to create a structurally stable trench. In some implementations, at least a portion of the bottom of trough 808 may be sintered using a laser, such as laser 128, for example. Trough 808 may have a vertical aspect, as compared to the horizontal aspect of trough 708, for example. The resulting vertical profile of wire 806 may have a relatively narrow cross-section with respect to cosmic radiation that bombards surface 812 of the Moon.

FIG. 9 is a schematic cross-section of a trench 902 excavated in regolith 904 that includes a cast-in-place wire 906 filling a round trough 908 at the bottom of the trench, according to some embodiments. Sides 910 of trench 902 may be excavated at an angle from vertical to create a structurally stable trench. In some implementations, at least a portion of the bottom of trough 908 may be sintered using a laser, such as laser 128, for example.

FIG. 10 is a schematic cross-section of a trench 1002 excavated in regolith 1004 that includes a cast-in-place wire 1006 over-filling a round trough 1008 at the bottom of the trench, according to some embodiments. Sides 1010 of trench 1002 may be excavated at an angle from vertical to create a structurally stable trench. In some implementations, at least a portion of the bottom of trough 1008 may be sintered using a laser, such as laser 128, for example. Cast-in-place rectangular wire 1006 may overfill trough 1008 without spilling onto the entire bottom of the trench (outside the trough) depending on the viscosity of the molten metal as it exits the nozzle.

FIG. 11 is a top view of a process 1100 of excavating and refilling a trench 1102 during a process of placing and burying a wire, according to some embodiments. For example, BWP system 100 may perform process 1100 as the system moves forward, indicated by arrow 1104, through regolith 1106 on the surface of the Moon. At a leading edge of the process, excavation plow 106 at a front portion of the BWP system forces regolith 1106 upward and to one or both sides, as indicated by arrows 1107, of the forming trench. This displaced (excavated) regolith forms into mounds 1108 on one or both sides of trench 1102.

In some implementations, a roller 1109, which may be attached to excavation plow 106 or other part of system body 101, may be configured to roll on the bottom of trench 1102 to apply a downward compressive force to smooth and compact the underlying regolith.

Reverse plow 122 located at a back portion of BWP system 100 may bury placed wire 1110 with the excavated regolith 1108 by refilling, as indicated by arrows 1112, a portion of the trench that includes the wire. Location 1113 in trench 1102 is where molten metal drops onto the bottom of the trench to quickly solidify and form wire 1110, for example. After the wire burying process, wire 1110 may be buried under a layer 1114 of regolith fill. In some implementations, reverse plow 122 may have a shaped portion 1116 and a leading edge 1118 configured to drag regolith 1108 back into trench 1102.

In some embodiments, as mentioned above, BWP system 100 may be configured to place markers 1120 into or onto layer 1114 over buried wire 1110. Such markers may help prevent damage to the buried wire from activities, such as driving heavy equipment or future excavations, on the lunar surface.

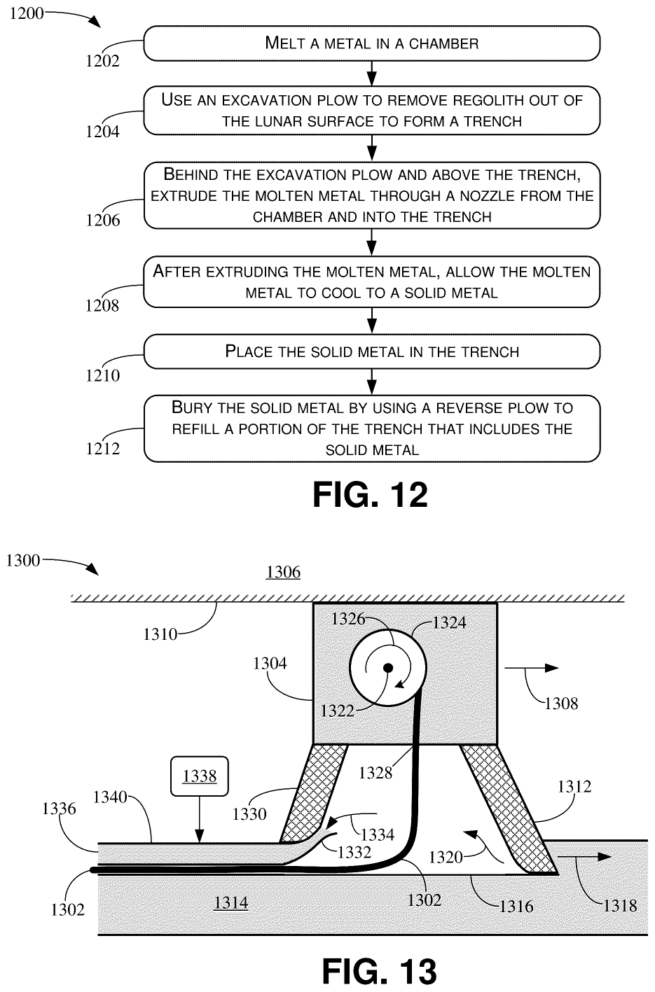

FIG. 12 is a flow diagram of a process 1200 of placing a wire and burying it in a trench, according to some embodiments. The process may be performed by an operator, which may be a person or persons, a computer processor executing computer-readable code, or a combination thereof. Process 1200 may be performed by the operator using a system that is the same as or similar to BWP system 100. Accordingly, for the present example, process 1200 is described using system 100. Though the following process description involves placing a single wire, two or more wires may be placed and buried in a trench by a process similar to or the same as process 1200. Claimed subject matter is not limited in this respect.

At 1202, the operator may melt a metal in chamber 113. Aluminum may be a preferred metal because its electrical conductivity is relatively high and its melting point is relatively low, as compared to other metals. The molten metal may be contained in chamber 113 until it is extruded into a trench. At 1204, the operator may use excavation plow 106 to remove regolith out of the lunar surface to form the trench. The excavation plow may push the removed regolith to one or both sides of the formed trench. The bottom of the trench, behind the excavation plow, may be irradiated with a laser to sinter the regolith upon which the formed wire will be placed. In addition to, or instead of, laser sintering, the regolith may be treated by other techniques, such as a rolling-compression technique or a sliding-flattening technique. A rolling-compression technique may involve a relatively small roller, such as 1109, that is configured to roll on a portion of the bottom of the trench while applying a downward vertical force to smooth and compact (e.g., compress) the underlying regolith. A sliding-flattening technique may involve a plate configured to slide on a portion of the bottom of the trench while applying a downward vertical force to smooth and compact (e.g., compress) the underlying regolith. The plate (not illustrated) may be attached to excavation plow 106 or other part of system body 101, for example.

At 1206, behind the excavation plow and above the trench, the operator may extrude the molten metal from chamber 113 through nozzle 140 and into the trench. The operator may adjust the rate of extrusion based on, among other things, the cooling rate of the extruded metal and the desired size (e.g., cross-sectional dimensions) of the resulting filament and/or wire.

At 1208, the operator may, after extruding the molten metal, allow the filament of molten metal to cool to a solid metal. This cooling may begin to occur immediately outside nozzle 140 and continue as the metal filament falls toward the bottom of the trench. The degree at which the filament is “solid” may depend, at least in part, on the rate of this cooling. For at least a part of the path of falling (from the tip of the nozzle to the bottom of the trench), the filament may be molten so as to be in a plastic state.

At 1210, the operator may place the (at least partially) solid metal in the trench by allowing the metal to fall from the extruding nozzle. At 1212, the operator may bury the solid metal by using reverse plow 122 to refill a portion of the trench with the regolith that was removed by excavation plow 106.

FIG. 13 is a schematic cross-section of a BWP system 1300 that dispenses prefabricated wire 1302, according to some embodiments. The BWP system, which may be mostly contained in a system body 1304, may be configured to operate on a moving vehicle 1306, as indicated by arrow 1308. For example, the system body of BWP system 1300 may be mounted to an underside 1310 of vehicle 1306. BWP system 1300 may include an excavation plow 1312 at a front portion of the BWP system to remove regolith 1314 out of the lunar surface to form a trench 1316. Excavation plow 1312 pushes forward, as indicated by arrow 1318, to force regolith 1314 out and to one or both sides, indicated by arrow 1320, of the developing trench. The system may include a spool holder 1322 configured to hold a spinning spool 1324 that spins to dispense wire 1302, as indicated by circular arrow 1326.

In some implementations, prefabricated wire 1302, which may be bare uninsulated wire, exits from system body 1304 through a dispense opening 1328. The prefabricated wire is then laid onto the bottom of trench 1316. A reverse plow 1330 may be located at a back portion of BWP system 1300 to bury the wire with excavated regolith 1332 by refilling, as indicated by arrow 1334, a portion of the trench that includes the wire. After the wire burying process, prefabricated wire 1302 may be buried under a layer 1336 of regolith fill.

In some implementations, BWP system 1300 may be configured to dispense and bury two (or more) wires substantially in parallel with each other in a trench. For example, though not illustrated, system 1300 may have a second spool holder and spool to dispense a second wire that is laid onto the trench bottom. Interestingly, neither of these wires, though relatively closely laid next to each other, will be electrically insulated, since the wires are formed directly from the molten metal. Lunar regolith, as mentioned above, in the dry vacuum of the Moon, has a relatively high electrical resistivity and is thus a very good electrical insulator.

In some embodiments, BWP system 1300 may be configured to place markers over buried wire 1302. Such markers may help prevent damage to the buried wire from activities, such as driving heavy equipment or future excavations, on the lunar surface. For example, system 1300 may include an apparatus 1338 that plants small markers or flags into surface 1340 on top of layer 1336 of regolith fill. In some implementations, apparatus 1338 may be configured to produce a particular texture to surface 1340, such as cross-hatching or lines, that can distinguish surface 1340 from the surroundings surfaces. This texture, which is effectively permanent if undisturbed by human activity, may be useful for indicating the presence of buried wire.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A method for placing wire in lunar regolith, the method comprising:
melting a metal in a chamber;
using an excavation plow to remove regolith out of the lunar surface to form a trench;
behind the excavation plow and above the trench, extruding the molten metal through a nozzle from the chamber and into the trench;
after extruding the molten metal, allowing the molten metal to cool to an at least partially solid metal;
placing the at least partially solid metal in the trench; and
burying the at least partially solid metal by using a reverse plow to refill a portion of the trench that includes the at least partially solid metal.

2. The method of claim 1, wherein a bottom portion of the trench is formed to create a predetermined cross-section of the at least partially solid metal in the trench.

3. The method of claim 1, wherein the metal is aluminum.

4. The method of claim 1, wherein the nozzle, the excavation plow, and the reverse plow are interconnected so as to be positioned substantially in a single line.

5. The method of claim 1, further comprising at least partially sintering the trench before placing the at least partially solid metal in the trench.

6. The method of claim 1, further comprising measuring at least one electrical property of the at least partially solid metal in the trench while extruding the molten metal.

7. The method of claim 1, further comprising placing markers on the refilled portion of the trench.

8. A buried-wire placement (BWP) system configured to operate on a moving vehicle, the BWP system comprising:
an excavation plow at a front portion of the BWP system to remove regolith out of the lunar surface to form a trench;
a chamber configured to melt a metal and hold the melted metal;
a temperature control system to adjust the temperature of the melted metal;
a nozzle at a middle portion of the BWP system configured to extrude the melted metal into the trench to form a wire, wherein the temperature of the extruded melted metal is adjusted by the temperature control system to adjust the temperature of the extruded melted metal to be in a liquid state or a plastic state between the nozzle and a bottom of the trench; and
a reverse plow at a back portion of the BWP system configured to bury the wire with the regolith by refilling a portion of the trench that includes the wire.

9. The BWP system of claim 8, wherein the excavation plow is configured to form a bottom portion of the trench into a shape that creates a predetermined cross-section of the wire in the trench.

10. The BWP system of claim 9, wherein the predetermined cross-section is rectangular.

11. The BWP system of claim 8, wherein the metal is aluminum.

12. The BWP system of claim 8, wherein the nozzle, the excavation plow, and the reverse plow are configured in the BWP system to be positioned substantially in a single line.

13. The BWP system of claim 8, further comprising a laser configured to sinter at least a portion of the trench before placement of the extruded melted metal in the trench.

14. The BWP system of claim 8, further comprising a sensor to measure at least one electrical property of the extruded melted metal and the wire in the trench while the melted metal is being extruded.

15. The BWP system of claim 14, wherein measurements of the at least one electrical property are based on a measurement of i) the melted metal in or near the nozzle and ii) a portion of the wire that is buried.

16. The BWP system of claim 15, further comprising a receiver for wirelessly receiving the measurement of the portion of the wire that is buried.

17. The BWP system of claim 8, wherein the nozzle is a first nozzle and the wire is a first wire, the BWP system further comprising a second nozzle adjacent to the first nozzle to extrude the melted metal into the trench to form a second wire substantially parallel to the first wire.

18. The BWP system of claim 8, further comprising:
a valve for controlling flow of the melted metal through the nozzle;
an imaging sensor focused on the wire on the bottom of the trench to capture images of the wire; and
a processor to i) analyze the captured images to determine one or more qualities of the wire on the bottom of the trench and ii) control the valve to adjust the flow of the melted metal based, at least in part, on the determined one or more qualities.

19. A buried-wire placement (BWP) system configured to operate on a lunar vehicle, the BWP system comprising:
an excavation plow at a front portion of the BWP system to remove regolith out of the lunar surface to form a trench;
a spool holder configured to hold a spool of non-insulated wire;
a dispenser at a middle portion of the BWP system configured to pull the non-insulated wire from the spool of the non-insulated wire and dispense the non-insulated wire into the trench; and
a reverse plow at a back portion of the BWP system configured to bury the non-insulated wire with the regolith by refilling a portion of the trench that includes the non-insulated wire.

20. The BWP system of claim 19, wherein the dispenser is a first dispenser and the non-insulated wire is a first non-insulated wire, the BWP system further comprising a second dispenser adjacent to the first dispenser to dispense a second non-insulated wire into the trench substantially parallel to the first non-insulated wire.
